(19) United States
(12) Patent Application Publication
(10) Pub. No.: US 2005/0079328 A1
(43) Pub. Date: Apr. 14, 2005

(54) Image-protecting film, and image-protecting method and overcoated recorded matter using the same

(75) Inventors: Hajime Mizutani, Nagano (JP); Hiroyuki Onishi, Nagano (JP)

Correspondence Address: Ladas & Parry, 26 West 61 Street, New York, NY, 10023, US

(73) Assignee: SEIKO EPSON CORPORATION

(21) Appl. No.: 10/849,497

(22) Filed: May 19, 2004

(30) Foreign Application Priority Data
May 23, 2003 (JP) P.2003-146586
May 11, 2004 (JP) P.2004-141119

(51) Int. Cl. B32B 3/00

(52) U.S. Cl. 428/195.1

(57) ABSTRACT

The present invention provides an image-protecting film having a protective layer releasably laminated on a support and to be heat transferred onto an image surface of recorded matter on which an image has been formed, wherein the surface of the support on which the protective layer is laminated has a surface roughness (Ra) according to JIS-B0601 of from 0.2 to 0.5. Further, an image-protecting method and overcoated recorded matter using the image-protecting film are also disclosed.

### FIELD OF THE INVENTION

The present invention relates to an image-protecting film for forming a protective layer on an image surface of recorded matter prepared by various recording systems such as an ink jet recording system, and particularly relates to an image-protecting film suitable for the preparation of matte (dull)-tone overcoated recorded matter, and an image-protecting method and overcoated recorded matter using the same.

### BACKGROUND OF THE INVENTION

An ink jet recording system is a recording system in which droplets of ink are ejected through minute nozzles of a recording head, and allowed to adhere to a recording medium such as paper, thereby forming an image. In recent years, coated paper for ink jet recording having the structure that an ink receiving layer mainly comprising fine porous particles such as silica or alumina has been developed, and high-quality ink jet images comparable with silver salt photographs have come to be obtained. With such an increase in image quality of ink jet images, importance has come to be attached to storage stability. The formation of ink jet images in which image deterioration caused by light, or water or oxidative gas in the air is hard to occur, and which can also withstand a little friction has become an important issue of the ink jet recording techniques.

As a means effective for improvement in storage stability of recorded matter and image quality, there has hitherto been known a method of forming a protective layer on an image surface (overcoating). As the overcoating, there are some methods according to the difference in the forming method of the protective layer. Examples thereof include: cold lamination in which a film that adheres at ordinary temperature is bonded to an image surface while peeling off backing paper of the film; heat (hot) lamination in which a thermoplastic film having no backing paper is bonded to an image surface; and heat transfer type overcoating in which an image-protecting film having the structure that a transparent film (protective layer) is releasably laminated on a support is used, and the transparent film is heat transferred to an image surface. Above all, the heat transfer type overcoating has the advantage that it can form a thinner protective film, compared to other methods, resulting in an increase in storage stability and image quality without imparting an excessive glossy texture to an image surface, and is used also in the protection of ink jet images. As an example in which the heat transfer type overcoating is applied to the ink jet images, there is known, for example, a transfer overcoat layer-having ink jet recording sheet obtained by heat transferring an overcoat resin layer comprising a thermoplastic resin as a main component via a heat resistant film onto the whole surface or a part of an ink receiving layer of an ink jet recording sheet on which an image has been formed (see patent document 1).

When the protective layer is formed on the image surface of recorded matter by the heat transfer type overcoating, the value of overcoated recorded matter finally obtained is largely dependent on the quality of the surface of the protective layer. Accordingly, it becomes important to select an image-protecting film suitable for the use of the overcoated recorded matter. For example, in the field of a special use for preparing large-sized posters or portraits, or recorded matter having a luxury appearance, a matte-tone image surface in which a glossy texture is delicately adjusted is chosen rather than an image surface smooth and excellent in the glossy texture in many cases. Accordingly, a film which can express such a matte tone is used as the image-protecting film.

As the matte tone-expressible image-protecting film, there is known, for example, a transfer sheet comprising a base film (support) and a coat layer (protective layer), wherein minute unevenness is provided on the surface of the base film on which the coat layer is formed (see patent document 2). Further, there is known a heat transfer sheet in which a gloss-expressing layer and a heat-sensitive adhesive layer (protective layer) are formed sequentially on a film base material (support), and a non-transfer gloss-adjusting layer mainly comprising particles and a resin binder is provided between the film base material and the gloss-expressing layer (see patent document 3). In these image-protecting films, the surface of the protective layer that constitutes a surface when heat transferred to an image surface is shaped by the surface having minute unevenness on which the coat layer is to be formed or by the gloss-adjusting layer to thereby be moderately roughened, so that the matte tone can be given to the overcoated recorded matter having the protective layer formed thereon.

Patent Document 1: JP 8-174989 A

Patent Document 2: JP 4-323088 A

Patent Document 3: JP 2002-178641 A

In the conventional matte tone-expressible image-protecting film, adjustment of a glossy texture (surface roughening) of the surface of the protective layer is not suitably performed. Accordingly, not only a desired matte texture is not expressed, but also a decrease in image density occurs, which causes deterioration in image quality in some cases. Further, in the matte tone-expressible image-protecting film, the protective layer is formed on the roughened surface (unevenness-formed surface) of the support, so that the adhesive force of the protective layer to the support tends to be strong, compared to an image-protecting film for imparting gloss in which a protective layer is formed on a smooth surface. The conventional matte tone-expressible image-protecting film is too strong in this adhesive force. Accordingly, when the support is peeled off at a final stage of heat transfer treatment, the protective layer which should stay on the surface to which the protective layer is transferred is taken by the support, resulting in the occurrence of trouble in the formation of the protective layer in some cases.

### SUMMARY OF THE INVENTION

Accordingly, an object of the invention is to provide an image-protecting film which can provide good matte-tone overcoated recorded matter giving a sedate texture without causing the disadvantages as described above, and an image protecting method and overcoated recorded matter using the same.

Other objects and effects of the invention will become apparent from the following description.

The present inventors have variously studied image-protecting films used in a heat transfer type overcoat method. As a result, it has been found that good matte-tone overcoated recorded matter for large-sized posters or portraits, or recorded matter having a luxury appearance without causing a decrease in image density or trouble in the transfer of a protective layer by adjusting the surface roughness (Ra) according to JIS-B0601 of the protective layer-laminating surface of a support within the specific range.

The invention has been made based on the above-mentioned finding, and the above-mentioned objects have been achieved by providing an image-protecting film having a protective layer releasably laminated on a support and to be heat transferred onto an image surface of recorded matter on which an image has been formed, wherein the surface of the above-mentioned support on which the above-mentioned protective layer is laminated has a surface roughness (Ra) according to JIS-B0601 of from 0.2 to 0.5.

Further, the invention provides an image-protecting method comprising integrating recorded matter on which an image has been formed, with the above-mentioned image-protecting film by heat pressing the above-mentioned protective layer onto an image surface of the recorded matter to form a laminated sheet, and then, peeling off the above-mentioned support from the above-mentioned laminated sheet, thereby forming a protective layer on the image surface.

Furthermore, the invention provides overcoated recorded matter having a protective layer for covering an image, on an image surface of recorded matter on which the image has been formed, wherein the protective layer is formed from the above-mentioned protective layer of the above-mentioned image-protecting film.

According to the image-protecting film and image-protecting method of the invention, the protective layer which can impart a good matte tone giving a sedate texture can be formed on a large-sized poster or portrait, recorded matter having a luxury appearance, or the like, without causing a decrease in image density or trouble in the transfer of the protective layer, which is extremely effective for improvement in image quality and storage stability.

### BRIEF DESCRIPTION OF THE DRAWINGS

FIG. 1 is a schematic cross sectional view showing one embodiment of an image-protecting film of the invention;

FIG. 2 is a schematic cross sectional view showing another embodiment of an image-protecting film of the invention; and

FIG. 3 is a schematic side view showing one embodiment of an image forming apparatus used for carrying out an image-protecting method of the invention.

The reference numerals and signs used in the drawings denote the followings, respectively:

1, 4: Image-Protecting Layer, 2: Support, 2a: Protective Layer-laminating surface of Support, 3: Protective Layer, 3a: Protective Layer Surface, 5: Surface Protective Layer, 6: Adhesive Layer, 10: Image Forming Apparatus, 11: Ink Jet Recording Unit, 12: Protective Layer Forming Unit, 13: Cutter, 14: Paper Catch Tray, M: Recording Medium, P: Recorded Matter, and OP: Overcoated Recorded Matter.

### DETAILED DESCRIPTION OF THE INVENTION

First, the image-protecting film of the invention will be described in detail below.

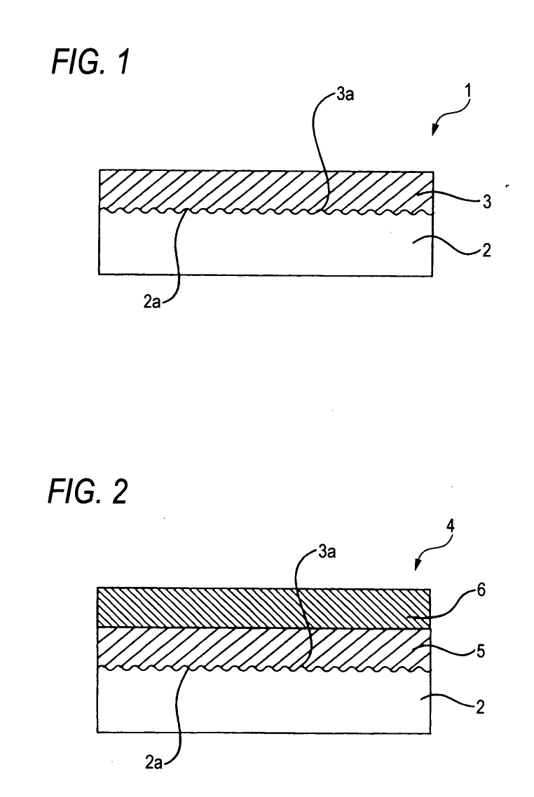

A schematic cross sectional view of an embodiment of the image-protecting film of the invention is shown in FIG. 1. This image-protecting film 1 has a support 2, and a protective layer 3 releasably laminated on one surface (protective layer-laminating surface 2a) of the support 2 and to be heat transferred onto an image surface of recorded matter on which an image has been formed. The protective layer-laminating surface 2a is a roughened surface having minute unevenness, and the facing surface 3a (which serves as a protective layer surface after heat transfer onto the image surface) of the protective layer 3 which adheres to the protective layer-laminating surface 2a is also similarly a roughened surface. The state (a wavy line) of the roughened surface shown in the drawing is indicated with emphasis for easy understanding, and different from the state of the actual roughened surface.

Then, the surface roughness (Ra) according to JIS-B0601 of the-protective layer-laminating surface 2a is from 0.2 to 0.5, and preferably from 0.25 to 0.45. When the Ra of the protective layer-laminating surface of the support is within such a range, the facing surface to the protective layer-laminating surface, that is, the surface (protective layer surface) forming a surface of the protective layer when the protective layer is heat transferred onto the image surface, is shaped by the protective layer-laminating surface, whereby the surface is moderately roughened. As a result, it becomes possible to impart a good matte tone giving a sedate texture to the image surface while sufficiently maintaining reflection density of the image. When the Ra of the protective layer-laminating surface of the support is less than 0.2, the protective layer surface insufficiently roughened, resulting in failure to impart the good matte tone to the image surface after the formation of protective layer. When the Ra of the protective layer-laminating surface of the support exceeds 0.5, there is a fear of causing a decrease in image density or poor transfer of the protective layer. In this specification, the surface roughness (Ra) means the average value of the absolute deviation values from the average line on the surface of the support.

The above-mentioned “protective layer which can impart a good matte tone giving a sedate texture to the image surface” obtained by adjusting the Ra of the protective layer-laminating surface of the support to 0.2 to 0.5 specifically means a protective layer in which the 60-degree specular gloss according to JIS-Z8741 of the surface thereof (protective layer surface) is within the range of 10 to 30%. The surface protective layer having a 60-degree specular gloss within such a range has an Ra falling within the range of approximately 0.2 to 0.4.

As a material for the support, there is preferably used one having such heat resistance that the shape thereof can be stably maintained under specified heating and pressing conditions upon the heat transfer, and being easily releasable from the protective layer pressed on the image surface. It includes, for example, a polyethylene terephthalate (PET) film. The above-mentioned surface roughness (Ra) of the PET film is usually at most about 0.05. Accordingly, in order to use such a PET film as the support according to the invention (the support in which the protective layer-laminating surface has an Ra value of 0.2 to 0.5), some adjustment for increasing the Ra value is necessary. Methods for adjusting the surface roughness include, for example, a method of allowing inorganic particles such as silica or titania to be contained in the PET film. Actually, a mixture of PET and the inorganic particles is formed into a sheet form to produce the PET film containing the inorganic particles. According to this method, a desired Ra value is obtained by appropriately adjusting the particle size and content of the inorganic particles. The inorganic particle-containing PET film obtained by this method can be used alone as the support, or laminated with an ordinary PET film (a PET film free from the inorganic particles) to form a two-layer structure support. In this two-layer structure support, the surface of the inorganic particle-containing PET film provides the protective layer-laminating surface. The image-protecting film in which the protective layer is formed on the inorganic particle-containing PET film serving as the support is largely different in gloss between the front and back surfaces, so that the front and back surfaces can be easily distinguished visually. Accordingly, a handling error such that the image-protecting film is set in a transfer apparatus with the front and back reversed can be prevented from occurring.

Other methods for adjusting the surface roughness of the film other than the above include surface-roughening treatment by spraying of inorganic particles such as silica or titania. The inorganic particles can be sprayed by the use of compressed air. According to this method, a desired Ra value is obtained by appropriately adjusting the particle size and the amount sprayed.

It is preferred that the support is made thin as much as possible from the viewpoints of suppressing the loss of the amount of heat given from a heating device such as a heat roll upon the heat transfer and giving adhesion between the protective layer and the recorded matter. However, when the support is too thin, not only handling becomes difficult, but also there is a fear of the occurrence of wrinkles on the protective layer and the inclusion of bubbles between the surface of the protective layer and the image surface upon the heat transfer. Considering these, the thickness of the support (when the support has the two-layer structure, the thickness of the whole two layers) is preferably from 2 to 100 μm, and more preferably from 6 to 50 μm.

Corona discharge treatment can be applied to the support as needed. By applying the corona discharge treatment to the support, it is possible to improve the affinity of a coating solution with respect to the support upon the formation of the protective layer and the adhesion of the protective layer to the support. The corona discharge treatment can be conducted by passing the support, which is a subject to be treated, through a space in which corona discharge is generated (for example, between a pair of electrodes facing each other), thereby increasing the wetting tension of the surface of the support. As a result, the adhesion of the protective layer is enhanced. Further, in order to enhance the releasability of the support after the protective layer has been pressed on the image surface, release treatment can also be applied to the protective layer lamination face of the support. A silicone resin, a polyolefin resin and the like can be used in the release treatment. When the release treatment is applied to the surface opposite to the protective layer-laminating surface (a surface on which no protective layer is laminated) of the support, it is effective for the prevention of blocking of films, the prevention of heat fusion to a heating device such as a heat roll, improvement in slipperiness in paper feeding, and the like.

On the other hand, the protective layer is preferably formed from a material excellent in chemical and physical barrier properties, transparency, adhesion to the image surface and the like, and capable of being moderately shaped by the protective layer-laminating surface of the support that is roughened as described above. Such materials include, for example, an acrylic copolymer, an acrylic-styrene copolymer, an acrylic-urethane copolymer, a vinyl acetate resin,-a vinyl acetate copolymer, a vinyl chloride-vinyl acetate copolymer, a vinyl chloride-acrylic copolymer, a vinyl acetate-acrylic copolymer, an acrylic-silicone copolymer and the like. In particular, an acrylic copolymer is preferably used in terms of transferability, storage stability and cost.

The structure of the protective layer is not limited to a single-layer structure as shown in FIG. 1, but may be a two-layer structure as shown in FIG. 2. In this image-protecting film 4, a surface protective layer 5 and an adhesive layer 6 are sequentially laminated on the protective layer-laminating surface 2a of the above-mentioned support 2. As materials for forming the surface protective layer 5 and the adhesive layer 6, the above-mentioned resins such as an acrylic copolymer can be used. The protective layer having such a two-layer structure provides an image-protecting film having adhesion to the image surface (mainly owing to the function of the adhesive layer), and image-protecting functions such as water resistance, light resistance, gas resistance and wear resistance, and blocking resistance and scratch resistance (mainly owing to the function of the surface protective layer), in a well-balanced manner.

The Tg of the above-mentioned adhesive layer itself is preferably from −20 to 60° C., and more preferably from −15 to 55° C., from the viewpoint of improving adhesion to the image surface while maintaining film forming properties necessary as a film. On the other hand, the Tg of the above-mentioned surface protective layer itself is preferably from −50 to 60° C., from the viewpoint of blocking resistance and scratch resistance.

It is preferred that the above-mentioned surface protective layer comprises a continuous phase formed of a thermoplastic resin and a dispersed phase formed of a thermoplastic resin dispersed in the continuous phase. The “thermoplastic resin forming the continuous phase” is preferably a resin which can express good film forming properties at a lower temperature than the “thermoplastic resin forming the dispersed phase”, and a resin having a Tg ranging from −50 to 60° C. is preferred. On the other hand, the “thermoplastic resin forming the dispersed phase” is preferably a resin having a Tg of 60° C. or higher, and the minimum film-forming temperature (MFT) thereof is preferably 100° C. or higher.

By constituting the above-mentioned surface protective layer with these continuous phase and dispersed phase, the following effects are given: 1) The blocking resistance and scratch resistance of the protective layer transferred onto the image surface is enhanced, 2) The releasability of the support upon the heat transfer process is improved, and 3) It becomes possible to prepare overcoated recorded matter whose end faces are made even without protrusion of the protective layer from the edges thereof. In general, when the protective layer-laminating surface of the support is roughened as described above, the adhesive force of the protective layer to the support increases, so that it becomes difficult to peel off the support. When the support is forcedly peeled off in such a state, there is a fear of exerting adverse effect on the finished quality of the overcoated recorded matter such that the protective layer to be adhered onto the image surface may be also peeled off, or a color material which forms an image may shift to disturb the image. However, the surface protective layer constituted as described above appropriately weakens the adhesive force of the protective layer to the support. As a result, it is presumed that the effect of the above-mentioned 2) (improvement in releasability of the support) is achieved. Further, the surface protective layer constituted as described above is characterized by relatively low mechanical strength of the layer itself and high cuttability (ease of being cut) of the layer. Such a protective layer having high cuttability is particularly effective when the protective layer is heat transferred to recorded matter smaller in size than the image-protecting film. When the large-sized image-protecting film is heat pressed on the recorded matter, and then, the support is peeled off, portions in the protective layer corresponding to the edges of the recorded matter (boundary portions between portions press-bonded on the recorded matter and portions protruded from the edges of the recorded matter without being press-bonded thereon) are cracked to cut off the protective layer protruded from the edges, thereby peeling off it together with the support. Thus, the effect of the above-mentioned 3) (the preparation of the overcoated recorded matter whose edges are made even) is achieved.

The ratio of the above-mentioned dispersed phase in the above-mentioned surface protective layer is preferably from 10 to 60% by weight based on the resin solid content in the surface protective layer. When the ratio of the dispersed phase is less than 10% by weight, the effects of the above-mentioned 1) to 3) are not sufficiently obtained. When it exceeds 60% by weight, there is a fear of inhibiting the film formation of a continuous layer.

Further, in addition to the method of constituting the surface protective layer by the continuous phase and the dispersed phase as described above, the effects of the above-mentioned 1) to 3) can also be obtained by a method of adding inorganic particles and/or a wax to the surface protective layer and/or the above-mentioned adhesive layer. When the protective layer has the single-layer structure as shown in FIG. 1, the effects of the above-mentioned 1) to 3) can be obtained by the method of adding inorganic particles and/or a wax. When the protective layer has the two-layer structure, it is also possible to constitute the surface protective layer by the continuous phase and the dispersed phase as described above and add inorganic particles and/or a wax to the surface protective layer and/or the above-mentioned adhesive layer. In this case, in the surface protective layer, it is preferred that the inorganic particles and/or the wax are contained in the continuous phase. Further, considering the functions of the surface protective layer and the adhesive layer, it is preferred that the content of the inorganic particles and/or the wax in the adhesive layer is smaller than that in the surface protective layer, and the adhesive layer may contain no inorganic particles and wax.

As the above-mentioned inorganic particles, colloidal silica is preferred. Further, the content of the above-mentioned inorganic particles is preferably from 10 to 60% by weight based on the resin content in the layer.

The above-mentioned waxes include, for example, paraffin wax (hydrocarbons having 20 to 40 carbon atoms), microcrystalline wax (hydrocarbons having 30 to 60 carbon atoms), carnauba wax (esters of fatty acids having 24 to 32 carbon atoms and alcohols), candelilla wax (fatty acids having 32 and 30 carbon atoms, alcohols and esters thereof), rice wax (esters of fatty acids having 16 to 32 carbon atoms and alcohols), Japan wax (glycerol esters also containing dibasic acids having 16 to 22 carbon atoms), bees wax (esters of fatty acids having 16 to 32 carbon atoms and alcohols, and hydrocarbons), spermaceti (esters of a fatty acid having 16 carbon atoms and alcohols), montan wax (esters of fatty acids having 20 to 32 carbon atoms and alcohols, and resinoids), ozokerite (hydrocarbons), ceresin (ozokerite purified to white), polyethylene wax, Fischer-Tropsch wax (hydrocarbons having 17 to 78 carbon atoms), amide wax (fatty acid amides or bisamides), hardened caster oil (caster wax, an ester of 12-hydroxystearic acid and glycerol), synthetic wax mainly comprising esters of monohydric alcohols and fatty acids and Guerbet wax (ester) obtained from the reaction of branched higher alcohols and fatty acids by the Guerbet reaction. They can be used either alone or a combination of two or more of them. Suitable commercially available waxes include Nopco 1245-M-SN and Nopco PEM-17 manufactured by San Nopco Ltd., and WF-640, W-700, W-200 and W-4005 of the Chemipearl series manufactured by Mitsui Petrochemical Industries, Ltd. The content of the wax is preferably from 1 to 10% by weight based on the resin content in the layer.

In addition to the above-mentioned resin components, the protective layer (surface protective layer or adhesive layer) can contain various additives such as an UV absorber, a light stabilizer, an antioxidant, a water resistance-imparting agent, a preservative, a viscosity improver, a fluidity improver, a pH adjusting agent, a leveling agent, a pigment and a dye, as welll as a film forming auxiliary such as butyl cellosolve, butyl carbitol, butyl cellosolve acetate, diethylene glycol, hexanol, 2-ethylhexanol or texanol.

The protective layer can be formed by dissolving or dispersing layer-forming materials in an appropriate solvent to prepare a coating solution, applying this coating solution onto the support by a conventional method, and drying it. In the case of the two-layer structure, the respective layers may be sequentially laminated on each other. The coating solution can be applied by a conventional method using a known coating apparatus such as a blade coater, an air knife coater, a bar coater or a roll coater.

The thickness of the protective layer is preferably from 2 to 20 μm, and more preferably from 5 to 15 μm, from the viewpoint of a balance between image protection characteristics such as water resistance, light resistance, gas resistance and wear resistance and the maintenance of an original texture of the recorded matter. In the case of the two-layer structure (the surface protective layer and the adhesive layer) as shown in FIG. 2, the thickness of the surface protective layer is preferably from 2 to 6 μm, considering to secure the image protection characteristics and necessary characteristics of the protective layer itself such as blocking resistance and scratch resistance. Further, the thickness of the adhesive layer is preferably from 2 to 6 μm, from the viewpoint of increasing heat transfer strength to adhere the protective layer to the image surface without the inclusion of bubbles.

The image-protecting method of the invention using the above-mentioned image-protecting film will be described below.

The image-protecting method comprises integrating recorded matter on which an image has been formed, with the above-mentioned image-protecting film by heat pressing the above-mentioned protective layer onto the image surface of the recorded matter to form a laminated sheet, and then, peeling off the above-mentioned support from the above-mentioned laminated sheet, thereby forming the protective layer on the image surface.

The above-mentioned recorded matter to which the image-protecting method of the invention is applied is prepared by imparting color materials to a recording surface of a recording medium to form an image. There is no particular limitation on the method for forming the image, and various recording systems such as an ink jet recording system, an offset printing system, a gravure printing system, a sublimation transfer system, a melt transfer system and an electrostatic toner recording system can be used. In particular, an ink jet recording system is preferred.

In the ink jet recording system, aqueous inks comprising an aqueous medium and a dye or pigment color material dissolved therein are used, and the aqueous inks are each ejected through nozzles of a recording head to impart color materials to the recording surface of the recording medium, thereby forming the image. In the invention, either a dye ink or a pigment ink can be used without problems, as long as it is an usual ink for ink jet recording. In general, the pigment ink is excellent in water resistance, light resistance and the like of a recorded image, but poor in color developability (image density). However, in the image-protecting method of the invention, diffused reflection of incident light contributing to a reduction in color developability is inhibited by covering the pigment ink image with the protective layer. As a result, color developability is enhanced, so that the defect of the pigment ink can be compensated.

Further, as the recording medium used in the preparation of the above-mentioned recorded matter, there may be appropriately selected one suitable for a recording system employed. When the ink jet recording system is employed, paper or general coating printing paper such as art paper or coated paper can also be used as the recording medium. However, when a full-color image of high quality and high grade is desired, coated paper for ink jet recording which has characteristics conforming to an aptitude for ink jet recording is preferred.

The above-mentioned coated paper for ink jet recording is coated paper constituted so that an ink receiving layer is provided on a base material. As the base material, there is used paper, a film, resin-coated paper or the like. The resin-coated paper comprises a paper sheet and a layer or layers of a polyolefin resin such as polyethylene provided on one side or both sides thereof, and is excellent in gloss, texture, water resistance and the like. Further, cockling (wrinkles or undulation) after printing is difficult to occur. Accordingly, paper of this type is suitable when photo-like recorded matter having a silver salt photograph tone is output. Further, the ink receiving layer is a porous layer containing inorganic particles such as amorphous silica, magnesium carbonate or alumina in an amount of about 40 to 90% by weight, and also contains polyvinyl alcohol or the like as a binder. The thickness of the ink receiving layer is preferably from about 20 to 50 μm.

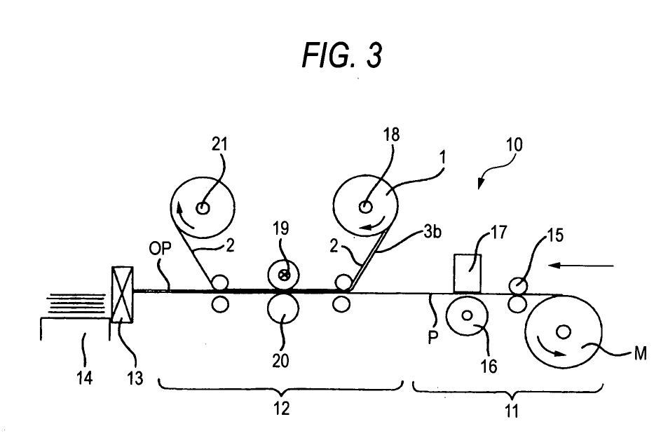

One embodiment of an image forming apparatus used for carrying out the image-protecting method of the invention is shown in FIG. 3. This image forming apparatus 10 comprises an ink jet recording unit 11 for ejecting an ink to a recording surface of a recording medium to form an image, and a protective layer forming unit 12 for forming a protective layer on the image. The above-mentioned image-protecting film 1 wound in a roll form is set in the protective layer forming unit 12. Further, in the rear of the protective layer forming unit 12, a cutter 13 for cutting a long sheet to a unit length and a paper catch tray 14 for stocking a plurality of cut sheets cut to the unit length are installed.

In the image forming apparatus 10 having such a structure, the ink jet recording unit 11 sends out a recording medium M in a roll form to a position of a platen 16 with a paper feed roll 15 driven by a motor not shown, and ejects each color ink from a recording head 17 to the recording surface thereof, depending on image information, to form the image, thereby preparing recorded matter P (an image forming process). The recorded matter P thus prepared is transferred to the protective layer forming unit 12.

In compliance with the recorded matter P transferred from the ink jet recording unit 11, a film feed roll 18 is rotated to send out the image-protecting film 1, and the recorded matter P and the image-protecting film 1 are laminated on each other so that the surface of the protective layer 3 thereof and the recording surface of the recorded matter P face each other (the image surface), and allowed to pass through a nip part between a heat roll 19 and a pressure roll 20 pressed on each other, at a specified transfer speed under a specified heating temperature and nip pressure. The heating temperature is set to a temperature higher than the glass transition temperature of the thermoplastic resin forming the protective layer. By this treatment, the protective layer 3 having adhesive properties is pressed on the image surface to form the laminated sheet in which the recorded matter P is integrated with the image-protecting film 1. Then, the support 2 is peeled off from the laminated sheet with a winding roll 21, thereby completing a protective layer forming-process.

The recorded matter (overcoated recorded matter) OP with the protective layer thus formed on the image surface is cut to a specified length with the cutter 13, and discharged onto the paper catch tray 14.

The image-protecting method of the invention has been described below, taking as an example the case of using the long recording medium (so-called machine glazed paper). However, for a cut sheet recording medium of A4 size or the like, the protective layer can also be formed in the same manner as described above.

### EXAMPLES

The present invention will be illustrated in greater detail below, but the invention should not be construed as being limited thereto.

### Example 1

A coating solution 1 for a surface protective layer and a coating solution for an adhesive layer having the following compositions are sequentially applied onto the whole surface of a protective layer-laminating surface of the following support 1, and dried to form the surface protective layer having a thickness of 4 μm and the adhesive layer having a thickness of 5 μm, thereby preparing an image-protecting film.

Support 1: Corona discharge treatment was applied to one side of a matte agent-containing PET film (Lumilar ×42, thickness: 38 μm, manufactured by Toray Industries, Inc.), and the surface subjected to the corona discharge treatment was used as a protective layer-laminating surface. The surface roughness (Ra) according to JIS-B0601 of this protective layer-laminating surface was 0.4.

Composition of Coating Solution 1 for Surface Protective Layer

| | |
|---|---|
| Movinyl 8020 | 47.6% by weight |
| (A colloidal silica-containing emulsion | |
| manufactured by Clariant Polymer Co., | |
| Ltd., Tg: −22° C.) | |
| Movinyl 790 | 31.7% by weight |
| (An acrylic emulsion manufactured by | |
| Clariant Polymer Co., Ltd., Tg: 102° C.) | |
| Snowtex 30 | 15.9% by weight |
| (Colloidal silica manufactured by Nissan | |
| Chemical Industries, Ltd.) | |
| Sanleaf CLA-3 | 3.8% by weight |
| (A wax emulsion manufactured by Sanyo | |
| Chemical Industries, Ltd.) | |
| Texanol | 1.0% by weight |
| (A film forming auxiliary manufactured | |
| by Chisso Corporation) | |

Composition of Coating Solution for Adhesive Layer

| | |
|---|---|
| Movinyl 727 | 99.0% by weight |
| (An acrylic emulsion manufactured by | |
| Clariant Polymer Co., Ltd., Tg: 16° C.) | |
| Texanol | 1.0% by weight |
| (A film forming auxiliary manufactured | |
| by Chisso Corporation) | |

### Example 2

An image-protecting film was prepared in the same manner as in Example 1 with the exception that the following support 2 was used in place of the support 1.

Support 2: Corona discharge treatment was applied to one side of a matte agent-containing PET film (Diafoil E-130, thickness: 38 μm, manufactured by Mitsubishi Polyester Film Corporation), and the surface subjected to the corona discharge treatment was used as a protective layer-laminating surface. The surface roughness (Ra) according to JIS-B0601 of this protective layer-laminating surface was 0.3.

### Example 3

An image-protecting film was prepared in the same manner as in Example 1 with the exception that a coating solution 2 for a surface protective layer having the following composition was used in place of the coating solution 1 for a surface protective layer.

Composition of Coating Solution 2 for Surface Protective Layer

| | |
|---|---|
| Movinyl 8020 | 48.5% by weight |
| (A colloidal silica-containing emulsion | |
| manufactured by Clariant Polymer Co., | |
| Ltd., Tg: −22° C.) | |
| Movinyl 790 | 32.4% by weight |
| (An acrylic emulsion manufactured by | |
| Clariant Polymer Co., Ltd., Tg: 102° C.) | |
| Snowtex 30 | 16.2% by weight |
| (Colloidal silica manufactured by Nissan | |
| Chemical Industries, Ltd.) | |
| Chemipearl W-4005 | 1.9% by weight |
| (A polyethylene wax emulsion manufactured | |
| by Mitsui Chemicals, Inc.) | |
| Texanol | 1.0% by weight |
| (A film forming auxiliary manufactured by | |
| Chisso Corporation) | |

### Example 4

An image-protecting film was prepared in the same manner as in Example 2 with the exception that a coating solution 3 for a surface protective layer having the following composition was used in place of the coating solution 1 for a surface protective layer.

Composition of Coating Solution 3 for Surface Protective Layer

| | |
|---|---|
| Movinyl 8020 | 47.6% by weight |
| (A colloidal silica-containing emulsion | |
| manufactured by Clariant Polymer Co., | |
| Ltd., Tg: −22° C.) | |
| Movinyl 790 | 31.7% by weight |
| (An acrylic emulsion manufactured by | |
| Clariant Polymer Co., Ltd., Tg: 102° C.) | |
| Texanol | 1.0% by weight |
| (A film forming auxiliary manufactured by | |
| Chisso Corporation) | |

### Example 5

An image-protecting film was prepared in the same manner as in Example 2 with the exception that a coating solution 4 for a surface protective layer having the following composition was used in place of the coating solution 1 for a surface protective layer.

Composition of Coating Solution 4 for Surface Protective Layer

| | |
|---|---|
| Movinyl 8020 | 47.6% by weight |
| (A colloidal silica-containing emulsion | |
| manufactured by Clariant Polymer Co., | |
| Ltd., Tg: −22° C.) | |
| Snowtex 30 | 15.9% by weight |
| (Colloidal silica manufactured by Nissan | |
| Chemical Industries, Ltd.) | |
| Sanleaf CLA-3 | 3.8% by weight |
| (A wax emulsion manufactured by Sanyo | |
| Chemical Industries, Ltd.) | |
| Texanol | 1.0% by weight |
| (A film forming auxiliary manufactured | |
| by Chisso Corporation) | |

### COMPARATIVE EXAMPLE 1

An image-protecting film was prepared in the same manner as in Example 1 with the exception that the following support 3 was used in place of the support 1.

Support 3: Corona discharge treatment was applied to one side of a matte agent-containing PET film (Diafoil E-180, thickness: 38 μm, manufactured by Mitsubishi Polyester Film Corporation), and the surface subjected to the corona discharge treatment was used as a protective layer-laminating surface. The surface roughness (Ra) according to JIS-B0601 of this protective layer-laminating surface was 0.15.

### COMPARATIVE EXAMPLE 2

An image-protecting film was prepared in the same manner as in Example 1 with the exception that the following support 4 was used in place of the support 1.

Support 4: Corona discharge treatment was applied to one side of a matte agent-containing PET film (Lumimat #200 trace, manufactured by Toray Industries, Inc.), and the surface subjected to the corona discharge treatment was used as a protective layer-laminating surface. The surface toughness (Ra) according to JIS-B0601 of this protective layer-laminating surface was 0.6.

For the respective image-protecting films prepared as described above, various values are shown in Table 1 described below.

TABLE 1

| | | Surface Protective Layer | | |
|---|---|---|---|---|
| | Support | Continuous | Dispersed Phase | Addition of |
| | Ra | Phase Tg | Tg | Silica·Wax |
| Example 1 | 0.4 | −22° C. | 102° C. | Added |
| Example 2 | 0.3 | −22° C. | 102° C. | Added |
| Example 3 | 0.4 | −22° C. | 102° C. | Added |
| Example 4 | 0.3 | −22° C. | 102° C. | Not added |
| Example 5 | 0.3 | −22° C. | No dispersed | Added |
| | | | phase | |
| Comparative | 0.15 | −22° C. | 102° C. | Added |
| Example 1 | | | | |
| Comparative | 0.6 | −22° C. | 102° C. | Added |
| Example 2 | | | | |

Preparation of Recorded Matter

Using a pigment ink jet printer (Crystario PPS-1, manufactured by Seiko Epson Corporation), a black color patch was printed on a recording surface of coated paper for ink jet recording having polyolefin resin-coated paper as a base material (PM photographic paper (gloss), manufactured by Seiko Epson Corporation) to prepare recorded matter.

Preparation of Laminated Sheet

Each of the above-mentioned image-protecting films was laminated on an image surface of the above-mentioned recorded matter so that a surface of the protective layer thereof and the image surface faced each other, and allowed to pass through a nip part between a pair of heat rolls pressed on each other, at a nip pressure of 1 kN/m, a roll surface temperature of 100° C. and a transfer speed of 10 mm/sec, thereby pressing the protective layer on the image surface to prepare a laminated sheet in which the recorded matter was integrated with the image-protecting film.

Test Examples

For the laminated sheets obtained as described above, transferability and cuttability of edges were each evaluated by the following methods. Further, for overcoated recorded matter obtained by peeling off the support from the above-mentioned laminated sheet, matte texture, color developability, 60-degree specular gloss, light resistance, gas resistance, blocking resistance, scratch resistance and storage stability in an album were each evaluated by the following methods. The results thereof are shown in the following Table 2.

Evaluation Method of Transferability

The support was peeled off from the above-mentioned laminated sheet at a peeling angle of 180 degrees and peeling speed of 100 cm/min, and the results visually observed at that time were evaluated according to the following evaluation criteria:

Evaluation Criteria
A: The protective layer does not come up from the image surface during the peeling of the support to cause no occurrence of blurring or peeling off of the image. Transferability is good.
B: The coming up of the protective layer from the image surface is partly observed during the peeling of the support, and the blurring or peeling off of the image is somewhat observed. However, it has practically no problem.
C: The coming up of the protective layer from the image surface is observed in considerable parts during the peeling of the support, and the blurring or peeling off of the image is significant. It is unpracticable.
   Evaluation Method of Cuttability of Edges

The support was peeled off from the above-mentioned laminated sheet in a diagonal direction of the sheet at a peeling angle of 180 degrees and peeling speed of 100 cm/min. Edges of the resulting overcoated recorded matter were visually observed and evaluated according to the following evaluation criteria:

Evaluation Criteria
A: An unnecessary transferred layer protruded from the edges is scarcely observed, and even when it is observed, the length of the protruded layer is less than 1 mm. Cuttability of edges is good.
B: An unnecessary transferred layer is protruded about several millimeters from the edges in some portions, but can be easily scraped off with a finger. It has practically no problem.
C: An unnecessary transferred layer is largely protruded from all of the edges of the overcoated recorded matter, and in order to remove the protruded layer, an operation such as breaking by picking or cutting becomes necessary. It is unpracticable.
   Evaluation Method of Matte Texture

To a striplight as a light source, the above-mentioned overcoated recorded matter was placed at a position where 60-degree reflection of incident light from the light source to a surface of the protective layer thereof was obtained, and the shape of the light source reflected on the surface of the protective layer (reflected shape) was visually observed. The case where the reflected shape was not confirmed was rated as A (good matte texture), the case where the reflected shape could be dimly confirmed was rated as B (relatively good matte texture), and the case where the reflected shape could be distinctly confirmed was rated as C (no matte texture).

Evaluation Method of Color Developability

For a color patch (black)-printed portion of the above-mentioned overcoated recorded matter, the optical density (OD) value was measured using a Macbeth densitometer RD918. The case where the OD value was improved more then 5% based on the OD value of the color patch (black)-printed portion previously measured before the formation of the protective layer was rated as A (good developability), the case where the rate of change of the OD value was within ±5% was rated as B (practically no problem), and the case where the OD value decreased more than 5% was rated as C (unpracticable).

Evaluation Method of 60-Degree Specular Gloss

For a surface of the protective layer of the above-mentioned overcoated recorded matter, the 60-degree specular gloss (%) was measured using a gloss meter GM-3D (manufactured by Murakami Color Research Laboratory). For a sample having a poor transfer portion, the gloss was measured at a portion having no poor transfer.

Evaluation Method of Light Resistance

Light exposure treatment of 450 kJ/m² was conducted to the above-mentioned overcoated recorded matter using a xenon weatherometer Ci35A manufactured by ATLAS under the conditions of a radiation energy at 340 nm of 0.25 W/m², a black panel temperature of 63° C. and a humidity of 50% RH. Then, for each sample the density decreasing rate at printed areas showing an OD value of 1.0 for Y, M and C between before and after the light exposure treatment was determined using a color difference meter. When this value was less than 3%, it was rated as A (a decrease in image density was scarcely observed, and light resistance was good), from 3% to less than 5% as B (practically no problem), from 5% to less than 10% as C (practical limit), and 10% or more as D (a decrease in image density was significant, and unpracticable).

Evaluation Method of Gas Resistance

The overcoated recorded matter was placed in a glass container having an inlet and an outlet, and ozone gas generated with a gas generator was introduce into the glass container at 1 ppm continuously for 100 hours to conduct gas treatment. Then, for each sample the density decreasing rate at printed areas showing an OD value of 1.0 for Y, M and C between before and after the gas treatment was determined using a color difference meter. When this value was less than 3%, it was rated as A (a decrease in image density was scarcely observed, and gas resistance was good), from 3% to less than 5% as B (practically no problem), from 5% to less than 10% as C (practical limit), and 10% or more as D (a decrease in image density was significant, and unpracticable).

Evaluation Method of Blocking Resistance

Two A-4 size sheets of the above-mentioned overcoated recorded matter were prepared, laminated on each other so that the surface of one sheet (the surface of the protective layer) and the back side of the other (the back side of PM photographic paper (gloss)) faced each other, and allowed to stand for 24 hours under the conditions of a room temperature of 50° C. and a relative humidity of 60% with a load of 300 g/cm² applied from above. Then, the laminated two sheets were peeled off from each other at a peeling angle (an angle between the protective layer and the recording medium-facing each other) of 130degrees and a peeling speed of 30 cm/min, and the state of the laminated face was visually observed and evaluated according to the following criteria:

Evaluation Criteria
A: No transfer of the protective layer to the above-mentioned back side is observed at all. Blocking resistance is good.
B: The protective layer is partially transferred to the above-mentioned back side, but it has practically no problem.
C: The protective layer is largely transferred to the above-mentioned back side, and it is unpracticable.
   Evaluation Method of Scratch Resistance

A surface of the protective layer of the above-mentioned overcoated recorded matter was lightly rubbed with plain paper (PPC), and then, visually observed. One in which the surface did not get scratched, or scratches were difficult to be visually confirmed even when the surface got scratched was rated as A (scratch resistance is good), one in which the surface got scratched was rated as B (practically no problem), and one in which the surface got scratched so deeply as to reach the vicinity of the image surface covered with the protective layer was rated as C (unpracticable).

Evaluation Method of Storage Stability in Album

The above-mentioned overcoated recorded matter was held in a free album manufactured by Kokuyo Co., Ltd. (inserted between a cover film and a mount to hold it), and this album was allowed to stand under circumstance of a room temperature of 60° C. and a humidity of 60% RH for 24 hours. Then, the recorded matter was taken out of the album, and the state at that time and the surface of the protective layer of the recorded matter taken out were visually observed and evaluated according to the following evaluation criteria:

Evaluation Criteria
A: When the recorded matter is taken out of the album, sticking between the cover film and the surface of the protective layer is scarcely observed, and there is no change in the state of the surface of the protective layer, compared to that before the recorded matter is held in the album. Storage stability in an album is good.
B: When the recorded matter is taken out of the album, the cover film and the surface of the protective layer partially stick to each other, but can be easily peeled off from each other. A change in gloss is small compared to that before the recorded matter is held in the album. It has practically no problem.

C: When the recorded matter is taken out of the album, the cover film and the surface of the protective layer stick to each other approximately in the whole area, and a change in gloss is large compared to that before the recorded matter is held in the album. It is unpracticable.

TABLE 2

| | | | | | 60-Degree | | | | | Storage |
|---|---|---|---|---|---|---|---|---|---|---|
| | | Cuttability | Matte | Color | Specular | Light | Gas | Blocking | Scratch | stability in |
| | Transferability | of Edges | Feeling | Developability | Gloss (%) | Resistance | Resistance | Resistance | Resistance | Album |
| Example 1 | A | A | A | A | 18 | A | A | A | A | A |
| Example 2 | A | A | A | A | 25 | A | A | A | A | A |
| Example 3 | A | A | A | A | 18 | A | A | A | A | A |
| Example 4 | B | B | A | A | 18 | A | A | B | B | B |
| Example 5 | B | B | A | A | 18 | A | A | B | B | B |
| Comp. | A | A | C | A | 54 | A | A | A | A | A |
| Example 1 | | | | | | | | | | |
| Comp. | C | A | A | C | 6 | A | A | A | A | A |
| Example 2 | | | | | | | | | | |

While the present invention has been described in detail and with reference to specific examples thereof, it will be apparent to one skilled in the art that various changes and modifications can be made therein without departing from the spirit and scope thereof.

The present application is based on Japanese patent application Nos. 2003-146586 (filed May 23, 2003) and 2004-141119 (filed May 11, 2004), the contents thereof being herein incorporated by reference.

1. An image-protecting film having a protective layer releasably laminated on a support and to be heat transferred onto an image surface of recorded matter on which an image has been formed,
wherein the surface of the support on which the protective layer is laminated has a surface roughness (Ra) according to JIS-B0601 of from 0.2 to 0.5.

2. The image-protecting film according to claim 1, wherein the protective layer heat transferred onto the image surface provides a surface having a 60-degree specular gloss according to JIS-Z8741 of from 10 to 30%.

3. The image-protecting film according to claim 1, wherein the support comprises a polyethylene terephthalate film containing inorganic particles, and the protective layer is releasably laminated thereon.

4. The image-protecting film according to claim 1, wherein the support comprises a polyethylene terephthalate film that has been subjected to surface-roughening treatment by spraying of inorganic particles, and the protective layer is releasably laminated thereon.

5. The image-protecting film according to claim 1, wherein the protective layer comprises a surface protective layer and an adhesive layer sequentially laminated from the support side,
wherein the surface protective layer comprises a continuous phase formed of a thermoplastic resin and a dispersed phase formed of a thermoplastic resin dispersed in the continuous phase,
wherein the thermoplastic resin forming the continuous phase has a glass transition temperature from −50 to 60° C., and the thermoplastic resin forming the dispersed phase has a glass transition temperature of 60° C. or higher.

6. The image-protecting film according to claim 1, wherein the protective layer contains inorganic particles and/or a wax.

7. An image-protecting method comprising:
integrating recorded matter on which an image has been formed, with the image-protecting film according to claim 1 by heat pressing the protective layer onto the image surface of the recorded matter to form a laminated sheet; and then,
peeling off the support from the laminated sheet, thereby forming a protective layer on the image surface.

8. The image-protecting method according to claim 7, wherein the recorded matter is a recording sheet that comprises polyolefin resin-coated paper having provided thereon an ink receiving layer, and has an image formed on the ink receiving layer by an ink jet recording system.

9. Overcoated recorded matter having a protective layer for covering an image, on an image surface of recorded matter on which an image has been formed, wherein the protective layer is formed from the protective layer of the image-protecting film according to claim 1.
